(19) United States
(12) Patent Application Publication
(10) Pub. No.: US 2003/0179754 A1
(43) Pub. Date: Sep. 25, 2003

(54) Two stage egress scheduler for a network device

(75) Inventors: Laxman Shankar, San Jose, CA (US); Shekhar Ambe, San Jose, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/247,299

(22) Filed: Sep. 20, 2002

Related U.S. Application Data
(60) Provisional application No. 60/365,510, filed on Mar. 20, 2002.

(51) Int. Cl. H04L 12/28

(52) U.S. Cl. 370/395.4

(57) ABSTRACT

A network device for network communications is disclosed. The device includes at least one data port interface, the at least one data port interface supporting at least one ingress data port receiving data and at least one egress port transmitting data. The device also includes a memory communicating with the at least one data port interface and a memory management unit including a memory interface for communicating data from the at least one data port interface and the memory. The memory management unit comprises a scheduler and a prefetch scheduler and the memory comprises at least two queues for containing packet data. Additionally, the prefetch scheduler is configured to fetch packet data from a first queue of the at least two queues and placing the packet data on a second queue of the at least two queues and the scheduler is configured to fetch packet data from the second queue and send the packet data to the at least one egress port.

### REFERENCE TO RELATED APPLICATIONS

This application claims priority of U.S. Provisional Patent Application Serial No. 60/365,510, filed on Mar. 20, 2002. The contents of the provisional application are hereby incorporated by reference.

### BACKGROUND OF THE INVENTION

1. Field of Invention

The present invention relates to network devices, including switches, routers and bridges, which allow for data to be routed and moved in computing networks. More specifically, the present invention provides for a two stage egress scheduler for assisting in the flow of data to the egress port of a network device and a network device having such a scheduler.

2. Description of Related Art

In computer networks, each element of the network performs functions that allow for the network as a whole to perform the tasks required of the network. One such type of element used in computer networks is referred to, generally, as a switch. Switches, as they relate to computer networking and to Ethernet, are hardware-based devices that control the flow of data packets or cells based upon destination address information, which is available in each packet or cell. A properly designed and implemented switch should be capable of receiving a packet and switching the packet to an appropriate output port at what is referred to wirespeed or linespeed, which is the maximum speed capability of the particular network.

Basic Ethernet wirespeed is up to 10 megabits per second, and Fast Ethernet is up to 100 megabits per second. Another type of Ethernet is referred to as 10 gigabit Ethernet, and is capable of transmitting data over a network at a rate of up to 10,000 megabits per second. As speed has increased, design constraints and design requirements have become more and more complex with respect to following appropriate design and protocol rules and providing a low cost, commercially viable solution.

One potential difficulty in reaching high-speed operation occurs when packets exit the network device. Packets queued up on an egress port of a network device need to be shaped and scheduled for transmission. This shaping is typically performed on a per class of service (CoS) basis. A dual leaky bucket algorithm is typically used to shape the packet stream on an egress port. The dual leaky bucket monitors at least two parameters, that are the maximum burst size (MBS) and the rate of transmission.

In a typical implementation, packets are stored in DRAM, which has higher access latency than SRAM. Packets are read into SRAM and then scheduled for transmission on the egress ports. The latency of accessing the SDRAM is hidden by using work conserving schemes to transmit packets on the egress port, but this is often inefficient. In addition, if there is flow control per CoS, Head of Line (HOL) blocking problems can occur, as explained below. These difficulties often affect the ability of a network device to provide the level of throughput desired.

As such, there is a need for an efficient and fair method of fetching and scheduling packets on to an egress port in the presence of flow control per CoS. In addition, there is a need for a method that allows for the weighting of the flows through the network device based on the number of bytes passing through and not simply the number of packets. Such a method of fetching and scheduling packets on to an egress port should also address the throughput differences of the different types of memory used in the egress port.

### SUMMARY OF THE INVENTION

It is an object of this invention to overcome the drawbacks of the above-described conventional network devices and methods. The present invention provides for a two stage egress scheduler for data packets passing through network devices.

According to one aspect of this invention, a network device for network communications is disclosed. The device includes at least one data port interface, the at least one data port interface supporting at least one ingress data port receiving data and at least one egress port transmitting data. The device also includes a memory communicating with the at least one data port interface and a memory management unit including a memory interface for communicating data from the at least one data port interface and the memory. The memory management unit includes a scheduler and a prefetch scheduler and the memory comprises at least two queues for containing packet data. Additionally, the prefetch scheduler is configured to fetch packet data from a first queue of the at least two queues and placing the packet data on a second queue of the at least two queues and the scheduler is configured to fetch packet data from the second queue and send the packet data to the at least one egress port.

Alternatively, the network device may have at least two series of queues, where each queue of the at least two series of queues is configured for packets having a particular class of service. Also, the prefetch scheduler may be configured to fetch packet data from a queue of a first series of queues for the particular class of service and place the packet data on a queue of a second series of queues for the particular class of service. Additionally, the prefetch scheduler may be configured to fetch packet data based on at least one fetching criterion, where that criterion may be selected such that the at least one egress port never has to wait for packet data to be fetched to the second queue.

Also, the network device may have a memory including dynamic random access memory and static random access memory wherein at least one of the at least two queues for containing packet data is configured in the dynamic random access memory. Also, the memory may further include at least one flow control bit register and wherein the scheduler may be configured to access the at least one flow control bit register to determine whether packet data should be fetched from the second queue. Also, the scheduler may be configured to fetch packet data based on at least one priority scheme, where the scheme may be at least one of a strict priority scheme, weighted round robin scheme and a weighted fair queuing scheme. Also, the scheduler may be configured to return a memory pointer position for the packet data upon request from the at least one egress port.

According to another aspect of this invention, a method of handling data packets in a network device is disclosed. Processed packets are placed into a first queue and at least one processed packet is fetched from the first queue based on at least one fetching criterion. The at least one processed packet is placed into a second queue and the at least one processed packet is fetched from the second queue based on at least one priority scheme for egress packets. Lastly, the at least one processed packet is sent to an egress port of the network device.

In other embodiments, the first and the second queues may be associated with a particular class of service, the first and second queues may be implemented in memory and the steps of fetching at least one processed packet comprises fetching at least one processed packet from memory. Additionally, the first queue may be implemented in dynamic random access memory and the second queue may be implemented in static random access memory. Also, the at least one fetching criterion may include fetching processed packets such that the egress port never has to wait for packet data to be fetched.

Additionally, the step of fetching the at least one processed packet from the second queue may include accessing a flow control bit for the second queue and fetching the at least one processed packet from the second queue only when the flow control bit has not been set. The step of sending the at least one processed packet to an egress port of the network device may include returning a pointer location in memory to the processed packet to the egress port, accessing processed packet data at the pointer location and sending the processed packet data out through the egress port. Additionally, the fetching steps may be performed concurrently. Also, the step of fetching the at least one processed packet from the second queue based on at least one priority scheme for egress packets may comprise fetching at least one process packet based on at least one of a strict priority scheme, weighted round robin scheme and a weighted fair queuing scheme.

These and other objects of the present invention will be described in or be apparent from the following description of the preferred embodiments.

### BRIEF DESCRIPTION OF THE DRAWINGS

For the present invention to be easily understood and readily practiced, preferred embodiments will now be described, for purposes of illustration and not limitation, in conjunction with the following figures:

FIG. 1 is a general block diagram of elements of an example of a network device according to the present invention;

FIG. 2 is a schematic view of the egress portion of a network device according to an existing implementation;

FIG. 3 is a schematic view of the egress portion of a network device according to one embodiment of the present invention;

FIG. 4 is a flow chart illustrating the processes carried out by the prefetch scheduler, according to one embodiment of the present invention; and

FIG. 5 is a flow chart illustrating the processes carried out by the scheduler, according to one embodiment of the present invention.

### DETAILED DESCRIPTION OF PREFERRED EMBODIMENTS

FIG. 1 illustrates a configuration of a node of the network, in accordance with the present invention. The network device 101 is connected to a Central Processing Unit (CPU) 102 and other external devices 103. The CPU can be used as necessary to program the network device 101 with rules that are appropriate to control packet processing. Ideally, the network 101 device should be able to process data received through physical ports 104 with only minimal interaction with the CPU and operate, as much as possible, in a free running manner. The present is directed to systems and processes involved in sending data processed by the network device to the egress ports to reach their respective destinations.

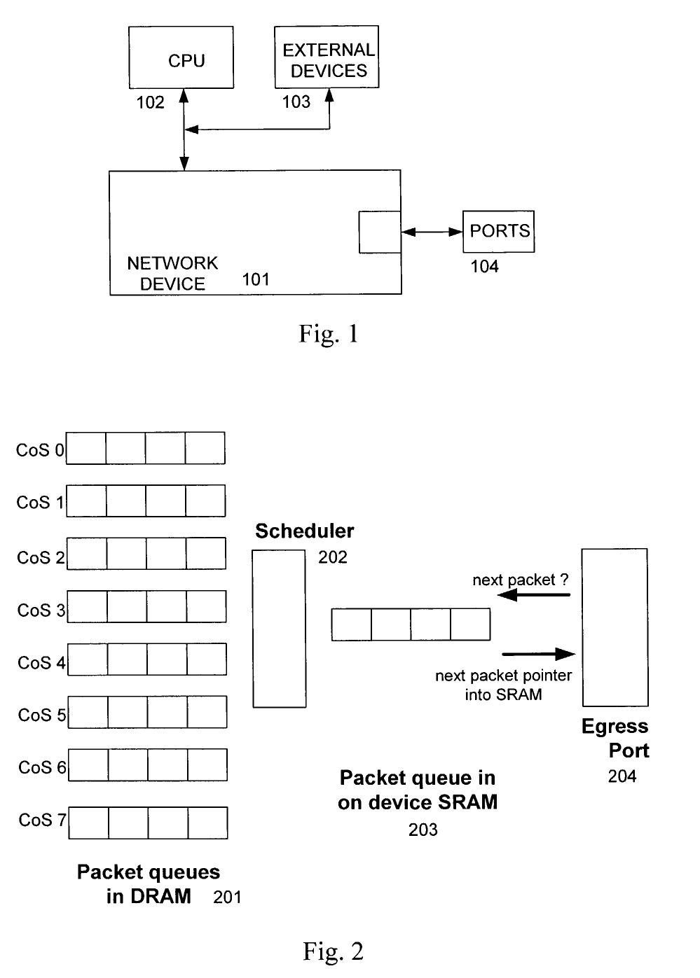

One implementation for egress scheduling of packets is shown in FIG. 2. In the current implementation, the scheduler 202 uses some scheduling policy like strict priority (SP), weighted round robin (WRR) or a combination to schedule packets for the egress port. In order to schedule packets for transmission, the memory management unit (MMU) transfers the next packet scheduled by the scheduler from the DRAM 201 to the on chip SRAM 203. It then queues the packet to be sent to the egress port 204 in a single queue of packet descriptors. Whenever the egress port 204 requests a packet, the next packet queued in the egress queue 203 is transmitted out.

The above scheme works if there is no per CoS flow control. The idea behind flow control is to inhibit the sending station or host from sending additional frames to a congested port for a predetermined amount of time. While this flow control can ease congestion, it also gives rise to Head Of Line (HOL) blocking. HOL blocking is a phenomenon that occurs in an input-buffered switch wherein a packet is temporarily blocked by another packet either at the input buffer or at the output buffer. In other words, packets destined for non-congested ports can be delayed because a packet is blocked in front of other packets which would otherwise not be blocked. If flow control is exerted for any CoS, head of line (HOL) blocking will result for all other CoSs, since there is only a single egress queue 203 for packets in the SRAM.

Another problem with this scheme is that multiple packets are pulled out of a page in the DRAM at a time to optimize DRAM throughput. Hence, precise implementation for a weighted fair queuing scheme is not possible. Weighted Fair Queuing (WFQ) is a technique where bandwidth is shared between CoSes to ensure fairness and parameters like information rate and maximum burst size are controlled on a per CoS basis. In a particular implementation embodiment, the traffic will be shaped through WFQ according to user specified parameters of committed information rate, peak information rate, peak burst size and committed burst size per CoS. The committed information rate is the minimum rate of data transmission for the CoS and the peak information rate is the upper bound of that rate. The other parameters relate to the burst rates of data and the above two rates. Through these parameters, the shaping of the queues of packets can be controlled and the flow can be controlled on the number of bytes for each CoS.

Yet another problem, with the single stage schedulers in current implementations, is that packets are usually scheduled at packet granularity, or based on an entire packet, as opposed to the size of packets. Even when weighted fair queuing is applied to single stage schedulers, the implementation is not usually accurate since it does not take into account the SDRAM latency. All of the above limitations are overcome by the two stage egress scheduler of the present invention.

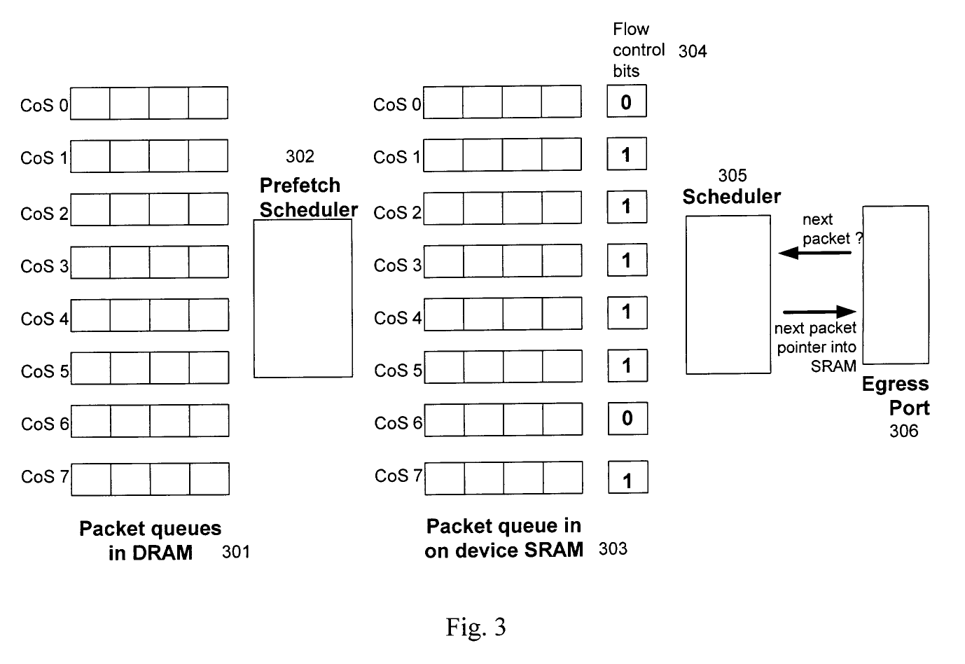

An innovative two-stage egress scheduler, according to one embodiment, is illustrated in FIG. 3. The two-stage scheduler has of a first stage, a Prefetch Scheduler (PS) 302, and a second stage, a scheduler (S) 305. The per CoS packet queues are still in the SDRAM 301. There is a set of per CoS descriptor queues in the SRAM 303. The PS 302 is responsible for transferring packets from the DRAM 301 to the SRAM 303 based on a specific policy configured for the system. This policy is independent of the scheduler's scheduling policy. Whenever the egress port 306 requests a packet, the next packet queued in the egress queues 303 is transmitted out. The scheduler responds to egress port requests by returning a pointer to the packet in SRAM whenever the egress port requests the next packet.

The Scheduler 305 can implement one of the following schemes: 1) Strict Priority (SP); 2) Weighted Round Robin (WRR), 3) SP plus WRR, and 4) Weighted Fair Queuing (WFQ). The scheduler implements a flow control mechanism overriding any of the above scheduling mechanism. There is one bit per CoS, i.e. flow control bits, as shown in FIG. 3.

A flow control bit is set to 1 when a pause message is received from a physical port for a CoS. No packets are scheduled for transmission from a CoS if the flow control bit is set to 1. When a resume message is received for a CoS, the flow control bit is set to 0.

The Prefetch Scheduler (PS) 302 is responsible for prefetching packets from the DRAM to the SRAM. One purpose of the PS 302 is to hide the latency of DRAM read access to achieve line rate egress port performance. Additionally, the PS also acts to decouple the process of fetching packets from the DRAM, thus optimizing the opening and closing of pages and at the same time achieving the fairness expected of the shaping algorithm chosen. The PS also allows packets to be prefetched into the SRAM for each CoS queue based on the scheduling policy chosen per CoS.

The number of packets fetched is chosen such that the egress port does not have to wait for a packet to be fetched from the DRAM. The worst case is when packets arrive at an egress port on a single CoS. In this case, the worst case is when there are only 64 byte (minimum size Ethernet) packets queued up and then a jumbo packet (10K byte) is fetched from the DRAM. In order to keep the egress port busy, there needs to be K packets such that:

DRAM access time for 1 jumbo=(K/Egress_port_rate), (1)

where Egress_port_rate is in (64 byte) packets/second.

In the other extreme case, a single jumbo packet is followed by another jumbo. Let the sum of the lengths of all prefetched, un-transmitted packets for the CoS be Lp. The next packet for a CoS is fetched from the DRAM if:

Lp<2*Jumbo Packet Size (2)

It is assumed that DRAM bandwidth is much greater than the Egress port bandwidth. When the scheduler schedules a packet from a CoS queue from transmission, the length of the packet is subtracted from Lp. That is,

Lp=Lp−Tx Packet Length (3).

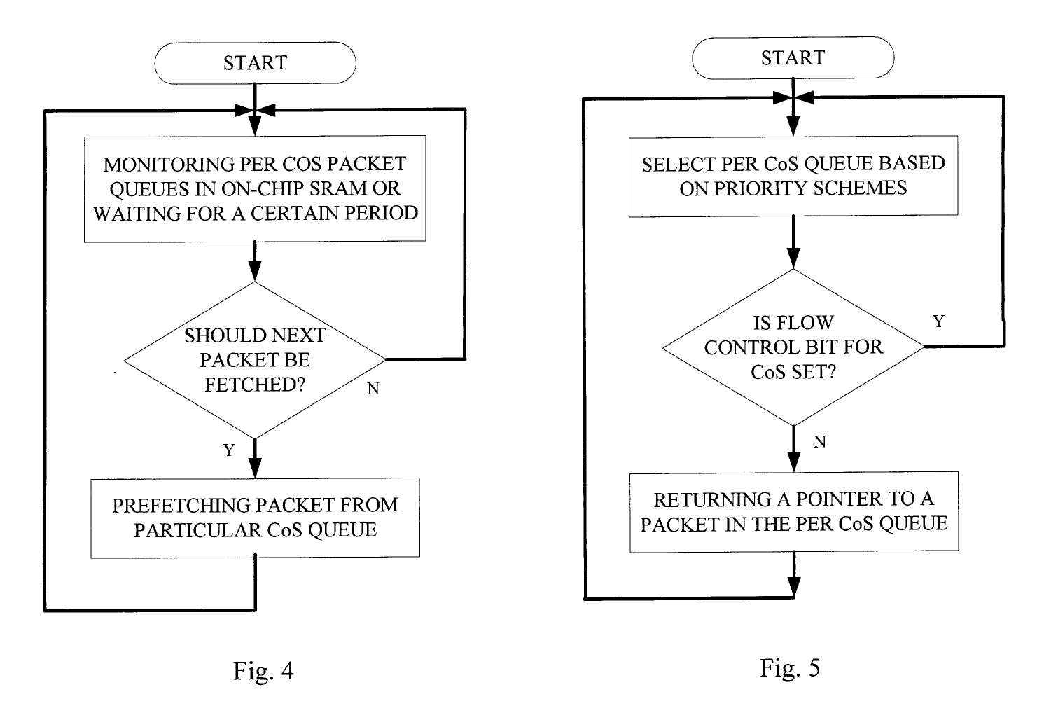

Flow charts for the processes carried out by the Prefetch Scheduler 302 and the Scheduler 305 are illustrated in FIGS. 4 and 5, respectively. For the Prefetch Scheduler, the PS monitors the queues or fetches packets such that the egress port never has to wait for a packet to be fetched from the DRAM. Such a determination is applied to decide whether a next packet is to be fetched from a particular CoS queue in DRAM. For the scheduler, the scheduler looks at the control bit for a particular CoS queue selected based on a priority scheme. If the bit is not set, then a pointer is returned to the egress port for a packet in the per CoS queue. If the control bit is set, then the scheduler selects another queue based on the priority scheme.

The above process and two stage egress scheduler allows per CoS flow control to operate without causing any head of line blocking and enable a true WFQ implementation. The present invention also allows for many types of scheduling policies to be implemented and provides for an efficient compensation for the higher access latency of the DRAM used in the packet queues.

The above-discussed configuration of the invention is, in one embodiment, embodied on a semiconductor substrate, such as silicon, with appropriate semiconductor manufacturing techniques and based upon a circuit layout which would, based upon the embodiments discussed above, be apparent to those skilled in the art. A person of skill in the art with respect to semiconductor design and manufacturing would be able to implement the various modules, interfaces, and components, etc. of the present invention onto a single semiconductor substrate, based upon the architectural description discussed above. It would also be within the scope of the invention to implement the disclosed elements of the invention in discrete electronic components, thereby taking advantage of the functional aspects of the invention without maximizing the advantages through the use of a single semiconductor substrate.

In addition, while the term packet has been used in the description of the present invention, the invention has import to many types of network data. For purposes of this invention, the term packet includes packet, cell, frame, datagram, bridge protocol data unit packet, and packet data.

Although the invention has been described based upon these preferred embodiments, it would be apparent to those of skilled in the art that certain modifications, variations, and alternative constructions would be apparent, while remaining within the spirit and scope of the invention. In order to determine the metes and bounds of the invention, therefore, reference should be made to the appended claims.

What is claimed is:

1. A network device for network communications, said network device comprising:
at least one data port interface, said at least one data port interface supporting at least one ingress data port receiving data and at least one egress port transmitting data;
a memory, said memory communicating with said at least one data port interface; and
a memory management unit, said memory management unit including a memory interface for communicating data from said at least one data port interface and said memory;
wherein said memory management unit comprises a scheduler and a prefetch scheduler and said memory comprises at least two queues for containing packet data, and wherein said prefetch scheduler is configured to fetch packet data from a first queue of said at least two queues and placing the packet data on a second queue of said at least two queues and the scheduler is configured to fetch packet data from said second queue and send the packet data to the at least one egress port.

2. A network device as recited in claim 1, wherein said at least two queues comprises at least two series of queues, where each queue of said at least two series of queues is configured for packets having a particular class of service.

3. A network device as recited in claim 2, wherein said prefetch scheduler is configured to fetch packet data from a queue of a first series of queues for said particular class of service and place said packet data on a queue of a second series of queues for said particular class of service.

4. A network device as recited in claim 1, wherein said prefetch scheduler is configured to fetch packet data based on at least one fetching criterion.

5. A network device as recited in claim 4, wherein said prefetch scheduler is configured such that at least one fetching criterion is selected such that the at least one egress port does not have to wait for packet data to be fetched to said second queue.

6. A network device as recited in claim 1, wherein said memory comprises dynamic random access memory and static random access memory, and wherein at least one of said at least two queues for containing packet data is configured in the dynamic random access memory.

7. A network device as recited in claim 1, wherein said memory comprises at least one flow control bit register, and wherein the scheduler is configured to access the at least one flow control bit register to determine whether packet data should be fetched from said second queue.

8. A network switch as recited in claim 1, said scheduler is configured to fetch packet data based on at least one priority scheme.

9. A network switch as recited in claim 8, wherein said priority schemes comprises at least one of a strict priority scheme, weighted round robin scheme and a weighted fair queuing scheme.

10. A network switch as recited in claim 1, wherein scheduler is configured to return a memory pointer position for the packet data upon request from the at least one egress port.

11. A method of handling data packets in a network device, said method comprising:
placing packets into a first queue;
fetching at least one packet from said first queue based on at least one fetching criterion;
placing said at least one packet into a second queue;
fetching said at least one packet from said second queue based on at least one priority scheme for egress packets; and
sending the at least one packet to an egress port of the network device.

12. A method as recited in claim 11 wherein each of the first and the second queues are associated with a particular class of service.

13. A method as recited in claim 11, wherein said first and second queues are implemented in memory and said steps of fetching at least one packet comprises fetching at least one packet from memory.

14. A method as recited in claim 13, wherein said first queue is implemented in dynamic random access memory and said second queue is implemented in static random access memory.

15. A method as recited in claim 11, wherein said step of fetching said at least one packet from said second queue comprises:
accessing a flow control bit for said second queue; and
fetching said at least one packet from said second queue only when said flow control bit has not been set.

16. A method as recited in claim 11, wherein step of sending the at least one packet to an egress port of the network device comprises:
returning a pointer location in memory to said packet to said egress port;
accessing packet data at the pointer location; and
sending said packet data out through the egress port.

17. A method as recited in claim 11, wherein said step of fetching at least one packet from said first queue based on at least one fetching criterion comprises fetching packets such that the egress port never has to wait for packet data to be fetched.

18. A method as recited in claim 11, wherein said fetching steps are performed concurrently.

19. A method as recited in claim 11, wherein said step of fetching said at least one processed packet from said second queue based on at least one priority scheme for egress packets comprises fetching at least one process packet based on at least one of a strict priority scheme, weighted round robin scheme and a weighted fair queuing scheme.

20. A network device for handling data packets, said network device comprising:
first placing means for placing packets into a first queue;
first fetching means for fetching at least one packet from said first queue based on at least one fetching criterion;
second placing means for placing said at least one packet into a second queue;
second fetching means for fetching said at least one packet from said second queue based on at least one priority scheme for egress packets; and
sending means for sending the at least one packet to an egress port of the network device.

21. A network device as recited in claim 20 wherein the first and the second queues are associated with a particular class of service.

22. A network device as recited in claim 20, wherein said first and second queues are implemented in memory and said first and second fetching means are configured to fetch at least one packet from memory.

23. A network device as recited in claim 22, wherein said first queue is implemented in dynamic random access memory and said second queue is implemented in static random access memory.

24. A network device as recited in claim 20, wherein said second fetching means comprises:
accessing means for accessing a flow control bit for said second queue; and
third fetching means for fetching said at least one packet from said second queue only when said flow control bit has not been set.

25. A network device as recited in claim 20, wherein said sending means comprises:
returning means for returning a pointer location in memory to said packet to said egress port;
accessing means for accessing packet data at the pointer location; and
second sending means for sending said packet data out through the egress port.

26. A network device as recited in claim 20, wherein said first fetching means comprises third fetching means for fetching packets configured such that the egress port never has to wait for packet data to be fetched.

27. A network device as recited in claim 20, wherein said first and second fetching means are configured to perform their functions concurrently.

28. A network device as recited in claim 20, wherein said second fetching means comprises third fetching means for fetching at least one process packet based on at least one of a strict priority scheme, weighted round robin scheme and a weighted fair queuing scheme.
